(19) United States
(12) Patent Application Publication
(10) Pub. No.: US 2006/0054283 A1
(43) Pub. Date: Mar. 16, 2006

(54) Joining apparatus

(75) Inventor: Akira Yamauchi, Otsu-shi (JP)

Correspondence Address: SMITH PATENT OFFICE, 1901 PENNSYLVANIA AVENUE N W, SUITE 901, WASHINGTON, DC, 20006, US

(73) Assignee: Toray Engineering Co., Ltd., Osaka-shi (JP)

(21) Appl. No.: 10/528,837

(22) PCT Filed: Sep. 25, 2003
(86) PCT No.: PCT/JP03/12205

§ 371 Date: Mar. 23, 2005

(30) Foreign Application Priority Data
Sep. 26, 2002 (JP) 2002-281111

(51) Int. Cl. B32B 37/00

(52) U.S. Cl. 156/580; 156/582

(57) ABSTRACT

A bonding apparatus comprising a cleaning chamber; cleaning means for irradiating energy waves to bonding surfaces in the cleaning chamber under a reduced pressure condition; bonding means for bonding metal bonding portions of objects to be bonded in an atmospheric air which have been taken out from the cleaning chamber; and carrying means for, with respect to at least one member of the objects to be bonded, carrying a foregoing object and an ensuing object substantially simultaneously in at least the carrying-in direction to the cleaning chamber and the carrying-out direction from the cleaning chamber. At the time of taking out the objects after cleaning into an atmospheric air and bonding them to each other, the carrying in, carrying out and delivery of objects to be bonded especially around the cleaning chamber can be performed smoothly within a short period of time, and mass production of desired bonded products can be realized at high throughput. As a result, it becomes possible to shorten the tact time through the entire bonding process and to reduce the cost required for the bonding process.

### TECHNICAL FIELD OF THE INVENTION

The present invention relates to bonding apparatus for bonding objects to be bonded each having a metal bonding portion on a surface of a substrate, such as chips, wafers or various circuit boards.

### BACKGROUND ART OF THE INVENTION

As a method for bonding objects to be bonded each having a bonding portion, Japanese Patent 2,791,429 discloses a bonding method of silicon wafers for, at the time of bonding the bonding surfaces of the silicon wafers to each other, sputter etching the bonding surfaces by irradiating an inert gas ion beam or an inert gas high-speed atomic beam to the surfaces at a vacuum condition with a room temperature prior to the bonding. In this bonding method, oxides or organic substances on the bonding surfaces of the silicon wafers are removed by the above-described beam and the surfaces are formed by atoms activated by the beam, and both surfaces are bonded to each other by a strong bonding force between the activated atoms. Therefore, in this method, basically heating for bonding is not necessary, and it is possible to bond the objects at a room temperature or a low temperature close to the room temperature merely by bringing the activated surfaces into contact with each other.

In this bonding method, however, the bonding of the etched bonding surfaces must be carried out in a vacuum at a condition where the surface activated state is maintained. Therefore, the predetermined vacuum condition must be maintained from the surface cleaning by the above-described beam to the bonding, and in particular, because at least a part of the mechanism for bonding must be constructed in a chamber capable of maintaining the predetermined vacuum degree, a large-scale sealing mechanism is required, and the whole of the apparatus becomes large and expensive. Further, if it is tried to carry out the surface cleaning and the bonding at different places for separating the surface cleaning process by the above-described beam and the bonding process from each other, it is required to maintain a predetermined vacuum condition between both places and mean for carrying the objects from a cleaning place to a bonding place while maintaining the predetermined vacuum condition is required, and therefore, it becomes difficult to design a practical apparatus and the whole of the apparatus becomes large.

With respect to the above-described method for bonding after surface cleaning by sputter etching due to beam irradiation, recently, a possibility of a method has been investigated, wherein, while the merit for bonding by the surface activation of the bonding surfaces as described above is maintained as much as possible, the bonding of the metal bonding portions of the object to be bonded to each other is performed in an atmospheric air. If such a bonding in an atmospheric air after surface activation becomes possible, as compared with a case of bonding in vacuum, the bonding process and apparatus can be greatly simplified.

However, in a case where, after a surface cleaning is performed in a cleaning chamber at a predetermined vacuum degree, bonding in an atmospheric air is carried out after taking out the objects from the chamber, particularly, mass production is performed continuously, because the vacuum degree in the cleaning chamber reduces at the time of carrying in the objects to the cleaning chamber and carrying out them from the cleaning chamber, it requires a long time to set a predetermined vacuum degree for cleaning again, and if such a time is required repeatedly for each object to be bonded, the throughput (treatment amount within a constant time) decreases, and therefore, a high productivity can not be achieved.

### DISCLOSURE OF THE INVENTION

Accordingly, an object of the present invention is to provide a bonding apparatus capable of producing bonded materials at a mass production system and at a high throughput using the above-described excellent bonding technology, by improving the carrying in, carrying out and delivery of objects to be bonded especially around a cleaning chamber while paying attention to the merit by the above-described bonding technology in an atmospheric air due to the surface activation recently developed.

To accomplish the above object, a bonding apparatus according to the present invention for bonding objects to be bonded each having a metal bonding portion on a surface of a substrate, comprises a cleaning chamber, cleaning means for irradiating energy waves to bonding surfaces of the metal bonding portions in the cleaning chamber under a reduced pressure condition, bonding means for bonding the metal bonding portions of the objects to be bonded in an atmospheric air which have been taken out from the cleaning chamber, and carrying means for, with respect to at least one member of the objects to be bonded, carrying a foregoing object and an ensuing object substantially simultaneously in at least a carrying-in direction to the cleaning chamber and a carrying-out direction from the cleaning chamber.

Namely, in the present invention, regardless of whether the objects to be bonded are carried one by one or carried at a plurality of members for each carrying, the foregoing object and the ensuing object are carried into the cleaning chamber and from the cleaning chamber, substantially simultaneously, namely, substantially together. By this, as compared with a case where the carrying in to the cleaning chamber and the carrying out from the cleaning chamber are performed in series, at least the time required for the carrying in and the carrying out can be shortened. As a result, the object cleaned in the cleaning chamber and carried out therefrom can be bonded in a very short period of time, and the time required for carrying in the ensuing object to the cleaning chamber and for cleaning it can be spent while overlapping the time required for a series of bonding steps, and various operations can be performed together. Therefore, in particular, in a case where the cleaning operation is carried out successively and the bonding operation is carried out succeedingly in order to achieve mass production, products can be produced at a high throughput. Desirably, by performing the operations at a synchronous formation or a formation similar thereto, for the delivery operation from the cleaning process to the bonding process, further, up to the bonding operation, in addition to the above-described carrying in to the cleaning chamber and carrying out from the cleaning chamber, it becomes possible to perform a series of operations up to completion of bonding together, and therefore, a mass production can be achieved at a further high throughput.

In this bonding apparatus, the above-described carrying means can employ various forms. For example, the carrying means can be formed as means having a tray capable of placing thereon a plurality of objects to be bonded, thereby performing the cleaning operation of a plurality of objects at a time. However, it is also possible to place an object onto a tray one by one and carry in and carry out the object.

A carrying-in port and a carrying-out port for the above-described tray of the cleaning chamber may be constructed as a common port. In a case of such a common port, the carrying in and the carrying out can be performed from one direction. In a case where the ports are constructed separately from each other, a structure can be employed wherein a carrying-in port and a carrying-out port of objects are provided at positions opposite to each other and the objects are carried at a one way.

Further, a structure can be employed wherein the carrying means has a carrying tape which holds a plurality of objects to be bonded arranged in a longitudinal direction of the carrying tape and which is fed intermittently at a predetermined feeding amount. The carrying tape is, for example, wound in a form of a roll, and the tape can be supplied at a continuous condition so as to be unwound therefrom and to pass through the inside of the cleaning chamber. In this case, although a continuous carrying tape portions exist at the carrying-in portion to the cleaning chamber and the carrying-out portion from the cleaning chamber of the carrying tape, by providing a sealing means for sealing a portion of the carrying tape positioning in the cleaning chamber from outside of the cleaning chamber, it becomes possible to perform the reduction of the pressure in the cleaning chamber to a predetermined vacuum degree easily without any problem. With the sealing means, for example, the carrying-in portion and the carrying-out portion of the tape can be sealed at a closed condition by pressing a contact portion with an elastic sealing member onto the tape, and when the tape is carried, the means for feeding the tape intermittently can be achieved by releasing the pressing.

Further, a structure can be employed wherein a sag is given to the above-described carrying tape at a position between the cleaning chamber and the bonding means. By this, even if there is a difference between a time interval of feeding in the cleaning place and a time interval of feeding in the bonding place, the difference can be appropriately absorbed by the above-described sag.

Further, a structure can be employed wherein the carrying means has means for performing together at least replacing for carrying in of an object to the cleaning chamber and replacing for carrying out of an object from the cleaning chamber one by one for the objects to be bonded. This means for performing together, for example, has a rotary head with a plurality of object holding heads.

Further, in the bonding apparatus according to the present invention, the cleaning chamber may be constructed as a cleaning chamber common for both members of the objects to be bonded to each other, and the cleaning chamber may be provided for each of both members of the objects to be bonded to each other.

Further, with respect to the cleaning chamber, a structure can be employed wherein a preparatory chamber for reducing pressure is attached to the cleaning chamber. For example, if the preparatory chamber for reducing pressure is provided before and after the cleaning chamber in the carrying direction of the objects, the variation in vacuum degree in the cleaning chamber between a predetermined vacuum degree at the time of cleaning and a reduced vacuum degree at the time of opening the cleaning chamber can be suppressed small, and a further high throughput becomes possible.

As the cleaning means for irradiating energy waves, a plasma irradiating means is preferred from the viewpoint of easiness of control of the intensity of the irradiated energy waves, and in particular, a plasma irradiating means under an Ar gas atmosphere condition is preferred.

Further, in order to further facilitate the bonding in an atmospheric air, it is preferred that the bonding means comprises any of a heating means for heating at a temperature of 180° C. or lower, preferably lower than 150° C., in order to accelerate the bonding between metals at a solid phase condition, a pressing means, means for applying a ultrasonic wave, and an energy wave cleaning means for bonding for cleaning the bonding surfaces by energy waves at the time of bonding (different from the energy waves at the time of the cleaning step), or an arbitrary combination thereof.

Further, in the present invention, in order to suppress the adhesion of a foreign material layer such as an oxide layer, an organic substance layer and a contamination layer onto the cleaned bonding surfaces as little as possible more surely from the cleaning step by the energy waves to the bonding step, a structure can be employed wherein the atmosphere for the bonding surfaces is purged by an inert gas such as Ar or N₂ or a non-oxidizing gas in a process up to the bonding step. This purge may be carried out locally. Namely, the bonding apparatus may comprise means for supplying an inert gas such as Ar or N₂ or a non-oxidizing gas locally to cleaned bonding surfaces in at least one process (preferably, all the series of the processes) of a carrying process of objects to be bonded, a holding process of objects to be bonded for bonding, and an aligning process of objects to be bonded for bonding after cleaning in the cleaning chamber through bonding of the metal bonding portions to each other.

The bonding in the present invention is suitable particularly for bonding in which bonding surfaces of metal bonding portions of objects to be bonded to each other are both formed from gold, and in a case of bonding golds to each other, they can be surely bonded even at a room temperature. The whole of electrodes, etc. forming the metal bonding portions may be formed from gold, and only the surfaces thereof may be formed from gold. The formation for forming the surfaces from gold is not particularly restricted, and the formation of gold plating or a thin gold film formed by sputtering or deposition may be employed. Further, especially in a case of employing a ultrasonic wave bonding, it becomes possible to bond different kind metals to each other, for example, gold/copper, gold/aluminum, etc., other than bonding of gold/gold, and besides, it becomes possible to bond these different kind metals to each other at a room temperature.

In the above-described cleaning by the energy waves, it is preferred that the cleaning means is means for irradiating energy waves at an energy capable of etching the bonding surfaces over the entire sputtering surfaces at a depth of 1.6 nm or more. By the energy wave irradiation at such an etching energy or more, it becomes possible to carry out a surface etching necessary to bond metal bonding portions to each other in an atmospheric air.

Further, it is preferred that the bonding means is means for making a dispersion of a gap between the metal bonding portions at the time of bonding to be 4 μm or less at maximum. If the dispersion of the gap is 4 μm or less, it becomes possible to suppress the gap within a dispersion of gap required for bonding the metal bonding portions to each other, by an appropriate bonding load.

Further, in order to achieve a good close contact between surfaces when the metal bonding portions are bonded to each other, it is preferred that a surface hardness of a metal bonding portion of at least one member of the objects to be bonded is set at 120 or less in Vickers hardness Hv, and the hardness is preferably reduced down to 100 or less by annealing. For example, the surface hardness Hv is preferably in a range of 30 to 70 (for example, an average Hv: 50). By seting the surface at such a low hardness, the surfaces of the metal bonding portions can be appropriately deformed and a closer contact becomes possible.

The present invention also provides a bonded material made by the above-described bonding apparatus. Namely, the bonded material of objects bonded to each other each having a metal bonding portion on a surface of a substrate, according to the present invention, is made by a bonding apparatus comprising a cleaning chamber, cleaning means for irradiating energy waves to bonding surfaces of the metal bonding portions in the cleaning chamber under a reduced pressure condition, bonding means for bonding the metal bonding portions of the objects to be bonded in an atmospheric air which have been taken out from the cleaning chamber, and carrying means for, with respect to at least one member of the objects to be bonded, carrying a foregoing object and an ensuing object substantially simultaneously in at least a carrying-in direction to the cleaning chamber and a carrying-out direction from the cleaning chamber.

In the above-described bonded material, at least one member of said objects bonded to each other can comprise a semiconductor.

In the above-described bonding apparatus according to the present invention, energy waves are irradiated to the bonding surfaces of the metal bonding portions of the objects to be bonded under a predetermined reduced pressure condition, and after the surfaces are cleaned and activated by etching, they are bonded to each other in an atmospheric air. Since foreign material layers of the bonding surfaces are sufficiently removed by the energy wave cleaning and the bonding is started at a condition where the surfaces are sufficiently activated, bonding at a room temperature becomes possible even at a bonding condition in an atmospheric air. If heating or pressing, further application of a ultrasonic wave, is carried out at the time of bonding, a further easy bonding in an atmospheric air becomes possible. Because bonding in an atmospheric air becomes possible, a large-scale vacuum device for bonding and a sealing device therefor become unnecessary, and the whole of the process and the whole of the apparatus can be simplified and cost down becomes possible.

Particularly in the present invention, because the carrying means is provided for, with respect to at least one member of the objects to be bonded, carrying a foregoing object and an ensuing object substantially simultaneously in at least a carrying-in direction to the cleaning chamber and a carrying-out direction from the cleaning chamber, in particular, because various operations around the cleaning step can be carried out together, bonded products can be produced at a condition of mass production and at a high throughput for the continuously sent objects to be bonded, the productivity can be increased greatly and the tact time of the whole of the bonding process can be shortened greatly.

Thus, in the bonding apparatus according to the present invention, when the objects whose bonding surfaces are cleaned by the energy waves are taken out into an atmospheric air and they are bonded to each other, the carrying in, carrying out and delivery of the objects to be bonded especially around the cleaning chamber can be performed smoothly within a short period of time, and mass production of desired bonded products can be realized at high throughput. As a result, it becomes possible to shorten the tact time through the entire bonding process and to reduce the cost required for the bonding process.

### BRIEF EXPLANATION OF THE DRAWINGS

FIG. 1 is a schematic diagram showing a basic constitution of a bonding apparatus according to an embodiment of the present invention.

FIG. 2 is a schematic diagram of a bonding apparatus showing an example of carrying means in the present invention.

FIG. 3 is a schematic plan view of the apparatus depicted in FIG. 2.

FIG. 4 is a schematic diagram of a bonding apparatus showing another example of carrying means in the present invention.

FIG. 5 is a schematic diagram of a bonding apparatus showing a further example of carrying means in the present invention.

FIG. 6 is a schematic diagram of a bonding apparatus showing a still further example of carrying means in the present invention.

FIG. 7 is a schematic diagram of a bonding apparatus showing a still further example of carrying means in the present invention.

FIG. 8 is a schematic diagram of a bonding apparatus showing a still further example of carrying means in the present invention.

FIG. 9 is a schematic diagram of a bonding apparatus showing another example of a structure around a cleaning chamber in the present invention.

FIG. 10 is a schematic diagram showing an example of the whole of a system of a bonding apparatus according to another embodiment of the present invention.

### EXPLANATION OF SYMBOLS

1: bonding apparatus
2, 3: metal bonding portion
2a, 3a: bonding surface
4: object to be bonded (chip)
4: object to be bonded (substrate)
6: vacuum pump
7: cleaning chamber
8: plasma irradiating means
9: plasma
10: special gas supplying pump
11: bonding place
12: waiting place
13: turning mechanism
14: head portion of turning mechanism
15: bonding head
16: bonding tool
17: bonding stage
18: heater as heating means
19: pressing means
20: position adjusting table
21: two-sight recognition means
22: ultrasonic wave applying means
23: energy wave cleaning means at the time of bonding
24: non-oxidizing gas supplying means
31: bonding place
32: cleaning chamber
33, 34: tray
35: carrying mechanism
36: common port
37: bonded material
41: bonding place
42: cleaning chamber
43: carrying-in port
44: carrying-out port
51: bonding place
52, 53: cleaning chamber
54: chip supplying portion
55: substrate supplying portion
56: place for bonding
61: carrying tape
62: cleaning chamber
63: bonding place
64: sag
65: sealing means
71: rotary head
72: cleaning chamber
81: cleaning chamber
82a, 82b: preparatory chamber for reducing pressure
141: chip
142: substrate
143: tray (work tray)
144: tray changer
145: cleaning chamber
146: special gas
147: tray loader
148: purge gas
159: stage table
150: waiting place
151: porous plate
152: purge nozzle
153: purge gas
154: lid
155: substrate replacing mechanism
156: holding head
157: bonding stage
158: purge gas
159: chip turning mechanism
160: holding head
161: bonding tool
162: purge gas
163, 164: purge nozzle
165, 166: purge gas
167: two-sight recognition means
168: bonding head
169: product tray
A: supplying station
B: cleaning station
C: bonding station
D: taking-out station

### THE BEST MODE FOR CARRYING OUT THE INVENTION

Hereinafter, desirable embodiments of the present invention will be explained referring to figures.

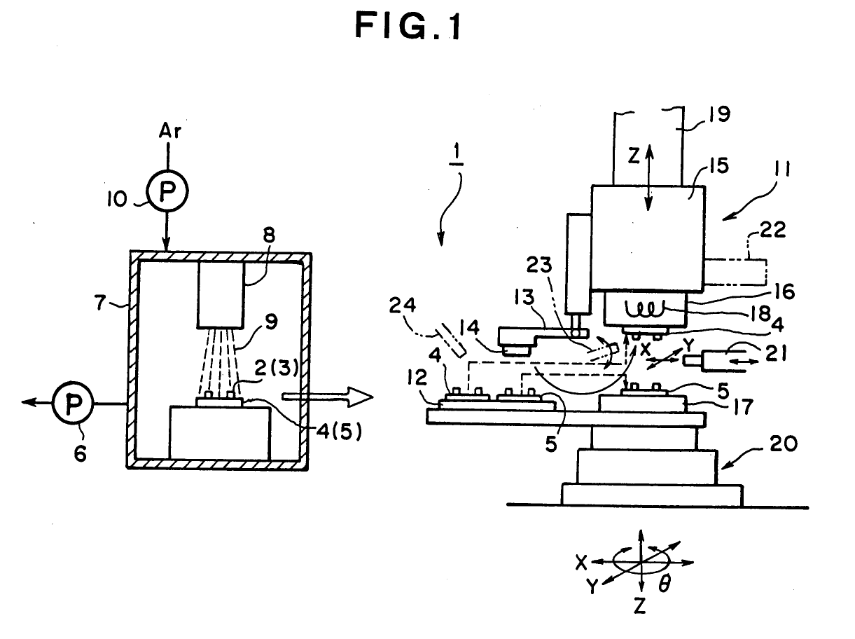

FIG. 1 shows a basic form of a bonding apparatus 1 according to an embodiment of the present invention, and portions other than carrying means in the present invention. An object to be bonded 4 or 5, which has a metal bonding portion 2 or 3 on a surface of a substrate, first, is cleaned in a cleaning chamber 7 which is reduced in pressure by a vacuum pump 6 at a predetermined vacuum degree, and the surfaces of metal bonding portions 2 and 3 are cleaned by etching by plasma 9 irradiated from plasma irradiating means 8 as cleaning means due to energy waves (cleaning process). In this embodiment, Ar gas is supplied into chamber 7 by a pump 10, and the plasma treatment is carried out under a condition of Ar gas atmosphere and under a condition of a predetermined reduced pressure. Cleaned objects 4 and 5 are taken out of cleaning chamber 7, and metal bonding portions 2 and 3 are bonded to each other in an atmospheric air at a bonding process (bonding place 11).

Where, the above-described object to be bonded 4 comprises a chip for example, and the object to be bonded 5 comprises a substrate for example. Where, the “chip” means all objects with forms being bonded to the substrate regardless the kind and size, such as an IC chip, a semiconductor chip, an optoelectronic element, a surface mounting part and a wafer. Further, the “substrate” means all objects with forms being bonded to the chip regardless the kind and size, such as a resin substrate, a glass substrate, a film substrate, a chip and a wafer. As a typical embodiment in the present invention, an embodiment can be raised wherein at least one object among the objects to be bonded is a semiconductor.

In bonding place 11, for example, the above-described cleaned objects 4 and 5 are set at a predetermined waiting place 12, after being carried in an atmospheric air. The object 4 is held by suction, etc. by a head portion 14 of a turning mechanism 13 not to touch the cleaned surface, and after turned over vertically, it is held by a bonding tool 16 provided at a lower portion of a bonding head 15, by suction, etc., in a form in which the metal bonding portion 2 is directed downward. The object 5 is held, for example, on a bonding stage 17, by suction, etc., in a form in which the metal bonding portion 3 is directed upward. The replacing mechanism for object 4 and the replacing mechanism for object 5 may be formed to be common, and may be formed separately from each other. In a case of providing them separately from each other, turning mechanism 13 is provided to the replacing mechanism for object 4 as described above. In this embodiment, a heater 18 is incorporated into bonding tool 16 as heating means, and, in an atmospheric air, bonding at a room temperature and bonding under a heated condition may be both possible.

Bonding head 15 can press object 4 downwardly via bonding tool 16 by pressing means 19, and can apply and control a predetermined bonding load to object 5. In this embodiment, bonding head 15 can be moved and positioned in a vertical direction (Z direction).

Further, in this embodiment, bonding stage 17 holding the above-described object 5 can align a position and adjust a parallelism relative to object 4 by controlling a horizontal position in X and Y directions, a vertical position in Z direction and a rotational position in a θ direction carried out by a position adjusting table 20 provided at a lower position. These alignment of the relative position and adjustment of the parallelism are carried out by reading recognition marks (not shown) provided to objects 4 and 5 or the holding means thereof by a recognition means inserted into a position between the objects 4 and 5 at a condition capable of progressing and retreating, for example, a two-sight recognition means 21 (for example, a two-sight camera), and performing a necessary correction in position and angle based on the read information. The two-sight recognition means 21 can be adjusted in position in X and Y directions, and as the case may be, in Z direction. Although these alignment of the relative position and adjustment of the parallelism are carried out mainly at the side of bonding stage 17 in this embodiment, it is possible to carry out these at the side of bonding head 15 or bonding tool 16, and further, at both sides.

Although any one of the heating by heater 18 as the heating means and the pressing by pressing means 19 or both can be employed in the above-described embodiment, other than the heating and the pressing, as shown by a two-dot line, it is possible to carry out the bonding by providing a ultrasonic wave applying means 22 to bonding head 15 or bonding tool 16 and utilizing or using together the ultrasonic wave application. Further, in a case where a foreign material layer adheres to the cleaned bonding surface more or less, in order to remove it immediately before bonding, an energy wave irradiating means at the time of bonding 23 may be provided for irradiating an energy wave (for example, atmospheric plasma) locally. Although the energy wave irradiating means at the time of bonding 23 is shown as an oscillating type in the example depicted in FIG. 1, it is possible to employ a structure capable of simultaneously cleaning the bonding surfaces of objects 4 and 5 the gap between which has been decreased, or a structure wherein the holding portions of objects 4 and 5 themselves are formed as an energy wave irradiating means at the time of bonding. Further, in addition to this energy wave irradiating means at the time of bonding 23, in order to suppress the adhesion of foreign material layer to the cleaned binding surfaces up to the bonding step as little as possible, a non-oxidizing gas supplying means 24 may be provided for supplying non-oxidizing gas locally to the cleaned bonding surfaces at at least one process of the object carrying process, the object holding process for bonding and the object alignment process for bonding, and purging the atmospheric atmosphere contacting the bonding surfaces as much as possible.

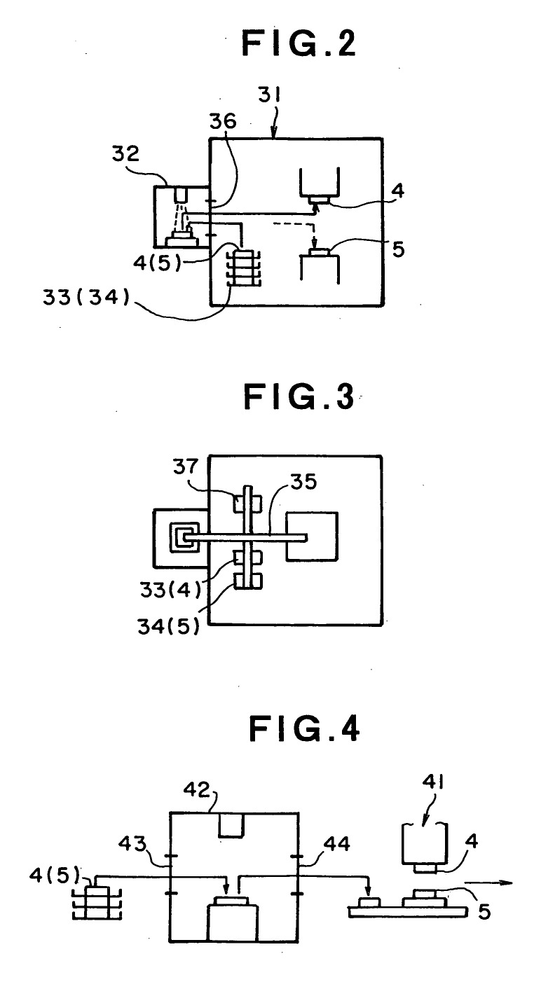

Next, the carrying means for, with respect to at least one member of the objects to be bonded, carrying a foregoing object and an ensuing object substantially simultaneously in at least a carrying-in direction to the cleaning chamber and a carrying-out direction from the cleaning chamber will be explained. As this carrying means, various forms can be employed. The basic constitutions of the various forms are shown in FIGS. 2 to 8. In FIGS. 2 to 8, although there is a case where the bonding place is depicted as if it is surrounded by a chamber in order to clearly distinguish the bonding place from the cleaning chamber, because the bonding is carried out in an atmospheric air, basically it is not necessary to employ such a chamber structure for bonding place.

FIGS. 2 and 3 show an example of the carrying means in the present invention. In this example, a cleaning chamber 32 according to the present invention is provided near to a bonding place 31 (a bonding apparatus portion, an apparatus similar to a conventional so-called bonder), and chips as objects to be bonded 4 and substrates as objects to be bonded 5 before cleaning are stocked. In this example, chip 4 and substrate 5 are placed on exclusive trays 33 and 34, respectively, and chip 4 and substrate 5 are carried into cleaning chamber 32 by carrying the respective trays 33 and 34 into the cleaning chamber 32, and the aforementioned cleaning by energy waves is performed in the cleaning chamber 32. At this time, each of chip 4 and substrate 5 may be placed on each of trays 33 and 34 one by one, and a plurality of chips 4 or substrates 5 may be placed on each of trays 33 and 34. Further, a structure may be employed wherein the trays are formed as common trays and both chip 4 and substrate 5 are placed on one tray, or they are placed one by one or at a plural form. The operation of carrying in and carrying out of the trays may be performed via an appropriate carrying mechanism 35 which has a robot arm, a slide mechanism, etc. Further, in a case where a chip tray and a substrate tray are cleaned separately from each other, the order may be decided arbitrarily as needed, and further, both trays may be cleaned simultaneously.

Chip 4 and substrate 5 whose bonding surfaces have been cleaned are carried out from cleaning chamber 32 together with the trays, and placed at waiting place 12 depicted in FIG. 1. In this example, because the carrying-in port and carrying-out port for the above-described trays of cleaning chamber 32 are formed as a common port 36, both the carrying-in operation and the carrying-out operation can be performed by opening/closing this common port 36. Because of common port 36, the object carried in from one direction is carried out in the direction after cleaning. Further, since both the carrying-in operation and the carrying-out operation can be performed substantially simultaneously at the time of opening the common port 36, the time required for a series of operations in mass production can be reduced totally, and mass production at a high throughput becomes possible.

After waiting at waiting place 12, chip 4 is turned over and replaced onto and held by bonding tool 16, and substrate 5 is replaced onto stage 17 at the attitude as it is and held thereon. After both objects are aligned in position, chip 4 and substrate 5 whose bonding surfaces have been activated are bonded to each other in an atmospheric air. A bonded material 37 (a product) of the chip 4 and the substrate 5 bonded to each other is once carried out onto a tray, the bonded material 37 or the tray is taken out to a taking-out place via the aforementioned carrying mechanism 35 or another exclusive carrying mechanism such as another robot arm (not shown).

Thus, in the bonding apparatus having cleaning chamber 32, since, with respect to at least one member of the object to be bonded, the foregoing and ensuing objects can be carried substantially simultaneously in at least the carrying-in direction to the cleaning chamber 32 and the carrying-out direction from the cleaning chamber 32, especially since the various operations around the cleaning process can be performed together, the total time required for these operations can be greatly shortened, and for a large number of objects sent continuously, bonded products can be produced in a form of mass production at a high throughput. Particularly in this example, it is also possible to perform together a series of operations of preparation for bonding of cleaned objects, bonding, and taking out after bonding, and therefore, the mass production can be performed at a further high throughput. Further, the objects carried out can be bonded in a very short period of time. As a result, the productivity can be greatly increased, and the tact time of the entire bonding process can be greatly shortened.

Although the carrying-in port and the carrying-out port of the cleaning chamber are formed as common port 36 and the objects can be carried in and carried out from the same direction in the above-described example, as shown in FIG. 4, in a case where the stock place of objects 4 and 5 before cleaning is different from bonding place 41, for example, it is located at an opposite position relative to cleaning chamber 42, a carrying-in port 43 and a carrying-out port 44 of cleaning chamber 42 may be provided separately from each other, and a series of operations from carrying in to carrying out may be performed in one direction as shown in the figure. Moreover, as an extension of the operations, a series of operations up to the bonding may be set as continuously flowing operations in the same direction. By thus carrying in the same direction or carrying as a series of continuously flowing operations, even if cleaning chamber 42 is added, a smooth carrying operation can be achieved while a short-time efficient cleaning can be achieved, and with respect to bonding in an atmospheric air, a mass production at a high throughput becomes possible.

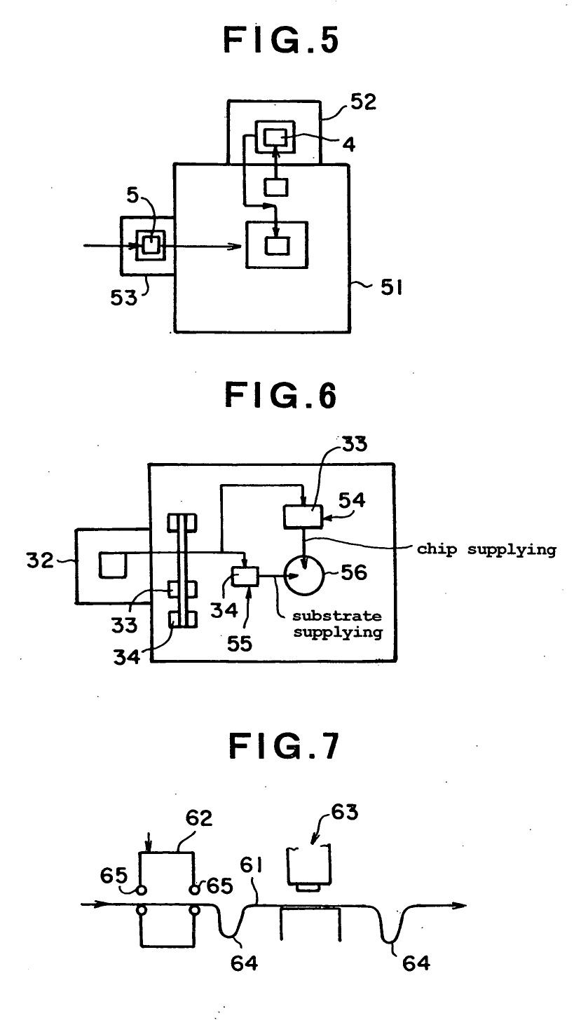

Further, although the cleaning chamber is formed as a common chamber for both chips and substrates in the examples shown in FIGS. 2 and 4, for example, as shown in FIG. 5, a cleaning chamber 52 for chips 4 and a cleaning chamber 53 for substrates 5 may be provided separately relative to bonding place 51, and chip 4 and substrate 5 cleaned in the respective cleaning chambers 52 and 53 may be bonded to each other in bonding place 51 in an atmospheric air. In such a structure, respective optimum cleaning conditions can be set for the respective cleaning chambers 52 and 53, and the treatments in cleaning chambers 52 and 53 can be proceeded substantially simultaneously, and a further high-throughput mass production as well as improvement in quality of bonded products become possible.

Further, as shown in FIG. 6, if a chip tray 33 and a substrate tray 34 are carried into a single cleaning chamber 32 to clean the chip and the substrate in the same chamber, a chip supplying portion 54 and a substrate supplying portion 55 are separated from each other at a position on the way of taking out of both trays and the chip and the substrate are supplied to a bonding place 56 together from those supplying portions, a high throughput can be achieved at a condition of a single cleaning chamber.

Further, in the present invention, as shown in FIG. 7, it is possible to use a carrying tape 61 for carrying of objects to be bonded. Chips or substrates are arranged and held on this carrying tape 61 at a predetermined pitch in the longitudinal direction of the tape, for example, the carrying tape 61 is supplied by being unwound from a roll, and the supplied carrying tape 61 is fed intermittently at a predetermined feeding amount as needed for the respective places. In the example shown, carrying tape 61 is firstly fed intermittently so as to pass through cleaning chamber 62, fed to bonding place 63 together with the cleaned objects, and it is possible to feed a bonded material together with the carrying tape 61 even after bonding. In consideration of a difference between times required for the respective processes, a sag 64 is given to carrying tape 61 at a position between cleaning chamber 62 and bonding place 63, and further, at a position after bonding place 63, and by increasing/decreasing the amount of the sag, a buffer function can be given to absorb the time difference between processes at the portion given with the sag.

Further, sealing means 65 are provided to the carrying-in portion and the carrying-out portion for carrying tape 61 of cleaning chamber 62 to seal the tape portion positioned in cleaning chamber 62 against outside of the cleaning chamber 62. Although the structure of sealing means 65 is not particularly restricted, in this example, it is constructed as a sealing member capable of being deformed elastically (for example, a sealing member made from a rubber), and it can nip carrying tape 61 cooperatively with the closing operation of cleaning chamber 62 and can seal both sides of the nipped portion from each other by the elastic deformation of itself at the time of nipping.

In the carrying operation using such a carrying tape 61, the carrying-in to cleaning chamber 62 and the carrying-out from cleaning chamber 62 can be performed smoothly and easily without accompanying with holding and releasing operations of the objects, and the high throughput can be further accelerated.

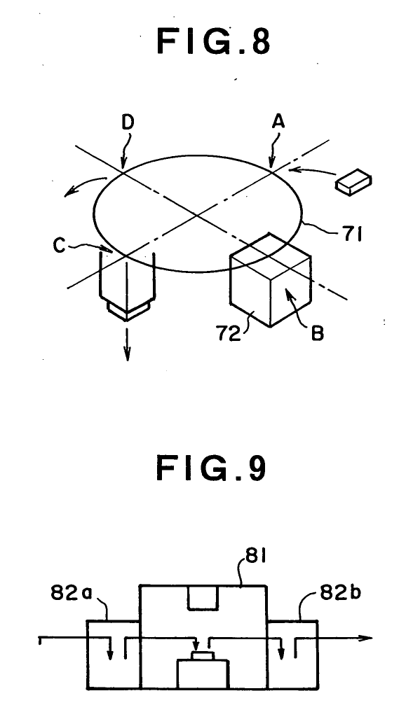

Further, the carrying means in the present invention may be constructed as means for performing together at least replacing for carrying in of an object to the cleaning chamber and replacing for carrying out of an object from the cleaning chamber one by one for the objects to be bonded, preferably, constructed as means for performing together from the operation for supplying objects before carrying-in operation to the operation for bonding the objects after cleaning. For example, as shown in FIG. 8, such means for performing together may be structured as a mechanism having a rotary head 71 with a plurality of object holding heads. This mechanism having rotary head 71 has a supplying station A supplied with the objects before cleaning, a cleaning station B with a cleaning chamber 72, and bonding station C for bonding the objects after cleaning, and further, may have a taking-out station D for the bonded materials after bonding. By providing such a rotary head 71, the respective operations at the respective stations can be performed substantially simultaneously, and a mass production at a high throughput becomes possible.

Further, in the present invention, in order to increase the sealing ability at the cleaning chamber, to shorten the time required for reaching a predetermined vacuum degree, and to suppress the variation of the vacuum degree after reaching due to the opening/closing operations of the cleaning chamber, for example, as shown in FIG. 9, it is preferred that preparatory chambers for reducing pressure 82a and 82b are provided before and after cleaning chamber 81. In a case where the objects are carried in and out in one direction as shown in FIGS. 2 and 3, a single preparatory chamber for reducing pressure may be enough. By providing such preparatory chambers for reducing pressure 82a and 82b, because at a closed condition of each preparatory chamber the side of the preparatory chamber of cleaning chamber 81 can be opened/closed, the reduction of the vacuum degree in cleaning chamber 81 can be suppressed to be small, and the time required for increasing the vacuum degree to a predetermined vacuum degree for cleaning can be shortened. Therefore, a mass production at a further high throughput becomes possible.

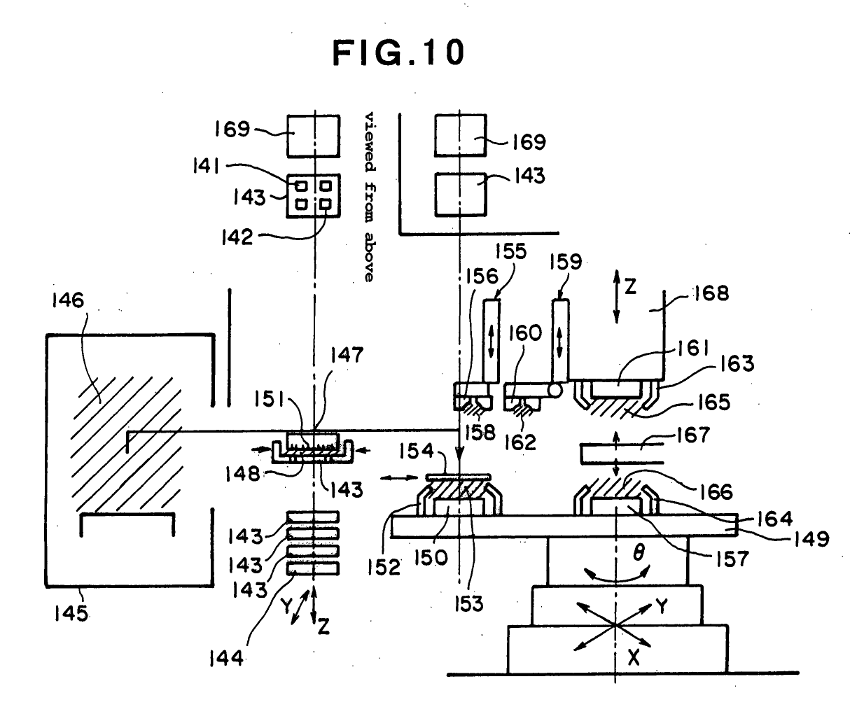

Thus, the present invention provides a bonding apparatus wherein objects cleaned by energy waves can be bonded at a form of mass production and at a high throughput, and in this bonding apparatus, as aforementioned, in order to suppress the formation of an oxide layer or an organic substance layer on the cleaned bonding surfaces before bonding as little as possible, it is preferred that means for supplying an inert gas or a non-oxidizing gas locally to the cleaned bonding surfaces in at least one process of a carrying process of objects to be bonded, a holding process of objects to be bonded for bonding and an aligning process of objects to be bonded for bonding after cleaning in the cleaning chamber through bonding of the metal bonding portions to each other, namely, means for purging the atmosphere on the bonding surfaces with the inert gas or the non-oxidizing gas, is provided. An example of a more concrete system of the whole of the bonding apparatus having such purge means in addition to the substantially simultaneous carrying-in to the cleaning chamber and carrying-out means from the cleaning chamber according to the present invention is shown in FIG. 10.

In FIG. 10, a tray 143 is taken out from a tray changer 144, on which trays 143 (work trays) each storing, for example, chip 141 and substrate 142, are stacked, and the tray 143 is carried into cleaning chamber 145. For this taking-out and carrying-in operation, a tray loader for taking out the tray may be used as described later, or another exclusive means may be used, and the carrying-in operation and the carrying-out operation relative to cleaning chamber 145 are performed together, substantially simultaneously. The inside of cleaning chamber 145 is replaced with a special gas 146 for generating a plasma (for example, Ar gas), for example, after vacuum operation, and the bonding surfaces of chip 141 and substrate 142 are cleaned by the plasma. Tray 143 placed thereon with the cleaned chip 141 and substrate 142 is carried out from cleaning chamber 145 by a tray loader 147, and while the atmosphere present on tray 143 placing thereon chip 141 and substrate 142 is purged with a purge gas 148 comprising the non-oxidizing gas or the special gas, it is carried to waiting place 150 on stage table 149. The above-described purge on tray loader 147 is carried out by supplying the non-oxidizing gas or the special gas, for example, via a porous plate 151.

In waiting place 150 on stage table 149, while being purged by purge gas 153 comprising the non-oxidizing gas or the special gas blown out from purge nozzle 152, the purge gas 153 is enclosed by a structure wherein a portion above waiting tray 143 is covered with a movable lid 154. After waiting, lid 154 is opened, and substrate 142 is held by suction by holding head 156 attached to a tip portion of substrate replacing mechanism 155, and the held substrate 142 is replaced onto bonding stage 157. Even in this case, because purge gas 153 is purged onto tray 143 by purge nozzle 152, other chips and substrates are covered with the purge gas. At that time, substrate 142 is held by suction after purge gas 158 comprising the non-oxidizing gas or the special gas is blown into holding head 156, and at the time of releasing the holding by suction when replaced onto bonding stage 157, the vacuum condition in the head is broken by blowing the purge gas 158 into holding head 156 again. Further, also for the side of chip 141, lid 154 is opened, chip 141 is held by suction by holding head 160 attached to a tip of chip turning mechanism 159, and after the held chip 141 is turned over, the chip 141 is replace onto the lower surface of bonding tool 161. Even in this case, because purge gas 153 is purged onto tray 143 by purge nozzle 152, other chips and substrates are covered with the purge gas. At that time, chip 141 is held by suction after purge gas 162 comprising the non-oxidizing gas or the special gas is blown into holding head 160, and at the time of releasing the holding by suction when replaced onto bonding tool 161, the vacuum condition in the head is broken by blowing the purge gas 162 into holding head 160 again.

For both of bonding tool 161 set with chip 141 and bonding stage 157 set with substrate 142, while the atmospheres on the surface of chip 141 and on the surface of substrate 142 are purged by purge gases 165 and 166 comprising the non-oxidizing gas or the special gas blown out from purge nozzles 163 and 164, respectively, the alignment is performed using a two-sight recognition means 167. After the alignment, two-sight recognition means 167 is retreated, bonding head 168 is moved down, chip 141 held on bonding tool 161 is bonded to substrate 142 held on bonding stage 157 by pressing, as needed, by applying heating together. After chip 141 is mounted onto substrate 142, the mounted product is taken out by substrate replacing mechanism 155 and stored in a product tray 169. When product tray 169 is filled with the products successively taken out, the product tray 169 is taken out to tray changer 144 stacking the product trays 169 by, for example, tray loader 147. Thus, the purge by the non-oxidizing gas or the special gas can be applied to various portions of processes for a series of operations.

### INDUSTRIAL APPLICATIONS OF THE INVENTION

The bonding apparatus according to the present invention can be applied to any bonding of objects to be bonded each having a metal bonding portion, and in particular, the bonding apparatus is suitable for bonding in a case where at least one object is a semiconductor.

1. A bonding apparatus for bonding objects to be bonded each having a metal bonding portion on a surface of a substrate, comprising:
a cleaning chamber;
cleaning means for irradiating energy waves to bonding surfaces of said metal bonding portions in said cleaning chamber under a reduced pressure condition;
bonding means for bonding said metal bonding portions of said objects to be bonded in an atmospheric air which have been taken out from said cleaning chamber; and
carrying means for, with respect to at least one member of said objects to be bonded, carrying a foregoing object and an ensuing object substantially simultaneously in at least a carrying-in direction to said cleaning chamber and a carrying-out direction from said cleaning chamber.

2. The bonding apparatus according to claim 1, wherein said carrying means has a tray capable of placing thereon a plurality of objects to be bonded.

3. The bonding apparatus according to claim 2, wherein a carrying-in port and a carrying-out port for said tray of said cleaning chamber are constructed as a common port.

4. The bonding apparatus according to claim 2, wherein a carrying-in port and a carrying-out port for said tray of said cleaning chamber are constructed separately from each other.

5. The bonding apparatus according to claim 1, wherein said carrying means has a carrying tape which holds a plurality of objects to be bonded arranged in a longitudinal direction of said carrying tape and which is fed intermittently at a predetermined feeding amount.

6. The bonding apparatus according to claim 5, wherein sealing means for sealing a portion of said carrying tape positioning in said cleaning chamber from outside of said cleaning chamber is provided to each of a carrying tape carrying-in portion to said cleaning chamber and a carrying tape carrying-out portion from said cleaning chamber.

7. The bonding apparatus according to claim 5, wherein a sag is given to said carrying tape at a position between said cleaning chamber and said bonding means.

8. The bonding apparatus according to claim 1, wherein said carrying means has means for performing together at least replacing for carrying in of an object to said cleaning chamber and replacing for carrying out of an object from said cleaning chamber one by one for said objects to be bonded.

9. The bonding apparatus according to claim 8, wherein said means for performing together has a rotary head with a plurality of object holding heads.

10. The bonding apparatus according to claim 1, wherein said cleaning chamber is constructed as a cleaning chamber common for both members of said objects to be bonded to each other.

11. The bonding apparatus according to claim 1, wherein said cleaning chamber is provided for each of both members of said objects to be bonded to each other.

12. The bonding apparatus according to claim 1, wherein a preparatory chamber for reducing pressure is attached to said cleaning chamber.

13. The bonding apparatus according to claim 1, wherein said cleaning means comprises means for irradiating plasma.

14. The bonding apparatus according to claim 13, wherein said cleaning means comprises an Ar plasma irradiating means.

15. The bonding apparatus according to claim 1, wherein said bonding means comprises a heating means.

16. The bonding apparatus according to claim 1, wherein said bonding means comprises a pressing means.

17. The bonding apparatus according to claim 1, wherein said bonding means comprises means for applying a ultrasonic wave.

18. The bonding apparatus according to claim 1, wherein said bonding means comprises an energy wave cleaning means for bonding for cleaning said bonding surfaces by energy waves at the time of bonding.

19. The bonding apparatus according to claim 1 further comprising means for supplying an inert gas or a non-oxidizing gas locally to cleaned bonding surfaces in at least one process of a carrying process of objects to be bonded, a holding process of objects to be bonded for bonding, and an aligning process of objects to be bonded for bonding after cleaning in said cleaning chamber through bonding of said metal bonding portions to each other.

20. The bonding apparatus according to claim 1, wherein bonding surfaces of metal bonding portions of objects to be bonded to each other are both formed from gold.

21. The bonding apparatus according to claim 1, wherein said cleaning means is means for irradiating energy waves at an energy capable of etching said bonding surfaces over the entire sputtering surfaces at a depth of 1.6 nm or more.

22. The bonding apparatus according to claim 1, wherein said bonding means is means for making a dispersion of a gap between the metal bonding portions at the time of bonding to be 4 μm or less at maximum.

23. The bonding apparatus according to claim 1, wherein a surface hardness of a metal bonding portion of at least one member of said objects to be bonded is set at 120 or less in Vickers hardness Hv.

24. A bonded material of objects bonded to each other each having a metal bonding portion on a surface of a substrate, made by a bonding apparatus comprising:
a cleaning chamber;
cleaning means for irradiating energy waves to bonding surfaces of said metal bonding portions in said cleaning chamber under a reduced pressure condition;
bonding means for bonding said metal bonding portions of said objects to be bonded in an atmospheric air which have been taken out from said cleaning chamber; and
carrying means for, with respect to at least one member of said objects to be bonded, carrying a foregoing object and an ensuing object substantially simultaneously in at least a carrying-in direction to said cleaning chamber and a carrying-out direction from said cleaning chamber.

25. The bonded material according to claim 24, wherein at least one member of said objects bonded to each other comprises a semiconductor.
